(19) United States
(12) Patent Application Publication
(10) Pub. No.: US 2026/0274033 A1
(43) Pub. Date: Sep. 17, 2026

(54) ROOF-MOUNTED AIR CONDITIONER AND VEHICLE

(71) Applicants: WUHU MATY AIR-CONDITIONING EQUIPMENT CO., LTD., Wuhu (CN); GD MIDEA AIR-CONDITIONING EQUIPMENT CO., LTD., Foshan (CN)

(72) Inventor: Yinyin ZHANG, Wuhu (CN)

(21) Appl. No.: 19/168,440

(22) PCT Filed: May 25, 2023
(86) PCT No.: PCT/CN2023/096411

§ 371 Date: Sep. 24, 2025

(30) Foreign Application Priority Data
Apr. 7, 2023 (CN) 202310391221.5
Apr. 7, 2023 (CN) 202320812021.8

(51) Int. Cl. B60H 1/00

(52) U.S. Cl. CPC B60H 1/00207; B60H 1/00364; B60H 2001/00235

(57) ABSTRACT

A roof-mounted air conditioner includes a housing provided with an indoor air duct assembly including an indoor air duct wall structure forming an indoor air duct and being made of a thermal insulation material, and a mounting structure including a support platform for mounting a fan motor or a bearing base. The at least one support platform is mounted at the housing and at least partially located within the indoor air duct; wherein a step is formed at a portion of the support platform located within the indoor air duct, and the step is provided with a water collection groove.

This application claims priority to Chinese Patent Application Nos. 202310391221.5 and 202320812021.8, both filed on Apr. 7, 2023, the entire contents of which are incorporated herein by reference.

### TECHNICAL FIELD

The present application relates to the technical field of roof-mounted air conditioner device, and in particular to a roof-mounted air conditioner and a vehicle.

### BACKGROUND

With economic development, people's pursuit of a higher quality of life in travel and tourism is increasing. Recreational vehicles (RVs), as a common living place for residents of developed European and American countries when travelling, have higher environmental requirements. Roof-mounted air conditioners, a key electrical device for improving the indoor environment, are gradually becoming standard equipment in RVs.

However, existing roof-mounted air conditioners used in RVs often suffer from poor thermal insulation in their interior air ducts, which often leads to internal cooling. This condensation is then blown toward users along with the wind, impacting the user experience.

### SUMMARY

### Technical Problem

The main purpose of the present application is to propose a roof-mounted air conditioner and a vehicle, aiming to solve the problem of poor thermal insulation performance of existing roof-mounted air conditioners.

### Technical Solution

In order to achieve the above purpose, the present application provides a roof-mounted air conditioner, including:
a housing provided with an indoor air duct assembly, the indoor air duct assembly including an indoor air duct wall structure forming an indoor air duct, the indoor air duct wall structure being made of a thermal insulation material; and
a mounting structure including at least one support platform for mounting a fan motor or a bearing base, the support platform being mounted at the housing and at least partially located within the indoor air duct,
a step is formed at a portion of the support platform located within the indoor air duct, and the step is provided with a water collection groove.

In an embodiment, the support platform is provided with a drainage hole communicating with the water collection groove.

In an embodiment, the indoor air duct wall structure includes:
an air duct support; and
an air duct cover provided above the air duct support and forming the indoor air duct therebetween,
the air duct support and the air duct cover are made of a thermal insulation material.

In an embodiment, the indoor air duct assembly further includes an air duct fixation cover provided above the air duct cover, and the air duct fixation cover is made of plastic.

In an embodiment, the mounting structure includes a bearing support platform and a motor support platform, at least one of the bearing support platform or the motor support platform forms the support platform, the roof-mounted air conditioner further includes a fan, the fan includes a motor, an impeller and a bearing base, the impeller is provided in the indoor air duct, the motor is mounted at the motor support platform, and the bearing base is mounted at the bearing support platform;
the housing includes:
a chassis on which the bearing support platform and motor support platform are mounted; and
a top cover covering an upper end of the chassis.

In an embodiment, a side of the air duct support corresponding to the impeller is inwardly recessed to form a curved wind surface.

In an embodiment, a width of the curved wind surface is greater than or equal to 15 mm, and a distance between the curved wind surface and the impeller is greater than 4 mm.

In an embodiment, the roof-mounted air conditioner further includes an indoor heat exchanger, the air duct support forms a water collection area, and the indoor heat exchanger is mounted at the water collection area and located within the indoor air duct.

In an embodiment, the indoor air duct assembly includes: an air duct support, an air duct cover, and an air duct fixation cover;
the air duct cover is provided above the air duct support to form the indoor air duct therebetween, and the air duct fixation cover is provided above the air duct cover; and
the air duct support is fixed to the chassis, and the air duct cover and the air duct fixation cover are fixed to an inner side of the top cover.

In an embodiment, the chassis, the bearing support platform, and the motor support platform are integrally formed.

In an embodiment, a cross-sectional area of the bearing support platform tapers away from the chassis.

In an embodiment, the air duct assembly further includes an air duct support, and a sealing step is formed at the air duct support corresponding to the upper side of the step.

In order to achieve the above purpose, the present application further provides a vehicle, including: a vehicle body, and the roof-mounted air conditioner as describe above is provided at a top of the vehicle body.

### TECHNICAL EFFECT

In technical solutions of the present application, by setting the indoor air duct wall structure of thermal insulation material, the inner wall of the indoor air duct is made of thermal insulation material, which improves the thermal insulation effect of the indoor air duct, thereby avoiding the formation of condensation water in the indoor air duct and the phenomenon of blowing water on the user. Besides, since the portion of the support platform located in the indoor air duct is not provided with thermal insulation material, condensation water will be formed at it. Accordingly, a water collection groove is provided on the support platform to collect the condensation water generated on the portion of the support platform located in the indoor air duct.

### BRIEF DESCRIPTION OF THE DRAWINGS

In order to more clearly illustrate the embodiments of the present application or the technical solutions in the related art, the following briefly introduces the drawings required for use in the embodiments or the description of the related art. Obviously, the drawings described below are only some embodiments of the present application. For ordinary technicians in this field, other drawings can be obtained based on the structures shown in these drawings without paying any creative work.

FIG. 1 is a schematic perspective view of a roof-mounted air conditioner according to an embodiment of the present application.

FIG. 2 is an exploded view of the roof-mounted air conditioner in FIG. 1.

FIG. 3 is a top view of an internal structure of the roof-mounted air conditioner in FIG. 1.

FIG. 4 is a cross-sectional view taken at line A-A in FIG. 3.

FIG. 5 is a cross-sectional view taken at line B-B in FIG. 4.

FIG. 6 is a partially enlarged view of portion C in FIG. 5.

FIG. 7 is a schematic perspective view of a chassis in FIG. 1.

FIG. 8 is a cross-sectional view of FIG. 7.

FIG. 9 is a top view of an air duct support in FIG. 1.

FIG. 10 is a front view of the air duct support in FIG. 9.

FIG. 11 is a side view of the air duct support in FIG. 9.

FIG. 12 is a schematic view of the air conditioner provided by the present application mounted on a vehicle body.

### DESCRIPTION OF REFERENCE SIGNS

TABLE 1

| Reference | | Reference | |
|---|---|---|---|
| sign | name | sign | name |
| 100 | roof-mounted air | 10 | air duct support |
| | conditioner | | |
| 20 | air duct cover | 30 | air duct fixation cover |
| 40 | housing | 41 | chassis |
| 42 | top cover | 50 | fan |
| 51 | motor | 52 | impeller |
| 53 | bearing base | 43 | bearing support |
| | | | platform |
| 44 | motor support platform | 45 | reinforcement rib |
| 46 | water collection groove | 47 | drainage hole |
| 11 | sealing step | 12 | curved wind surface |
| 60 | indoor heat exchanger | 13 | water collection area |

The realization of the objectives, functional features and advantages of the present application will be further explained in conjunction with embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the embodiments described are only part of the embodiments of the present application, not all of the embodiments. Based on the embodiments of the present application, all other embodiments obtained by ordinary technicians in this field without making creative efforts are within the scope of the present application.

It should be noted that if there is a directional indication (such as up, down, left, right, front, rear . . . ) in the embodiments of the present application, the directional indication is only used to explain the relative positional relationship, movement, etc. of the components in a certain posture (as shown in the drawings). If the specific posture changes, the directional indication will change accordingly.

In addition, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. Besides, the meaning of “and/or” appearing in the disclosure includes three parallel scenarios. For example, “A and/or B” includes only A, or only B, or both A and B. In addition, the technical solutions between the various embodiments can be combined with each other, but they must be based on the realization of those of ordinary skill in the art. When the combination of technical solutions is contradictory or cannot be achieved, it should be considered that such a combination of technical solutions does not exist, nor is it within the scope of the present application.

With economic development, people's pursuit of a higher quality of life in travel and tourism is increasing. Recreational vehicles (RVs), as a common destination for residents of developed European and American countries, have higher environmental requirements. Roof-mounted air conditioners, a key electrical device for improving the indoor environment, are gradually becoming standard equipment in RVs.

However, existing roof-mounted air conditioners used in RVs often suffer from poor thermal insulation in their interior air ducts, which often leads to internal cooling. This condensation is then blown toward users along with the wind, impacting the user experience.

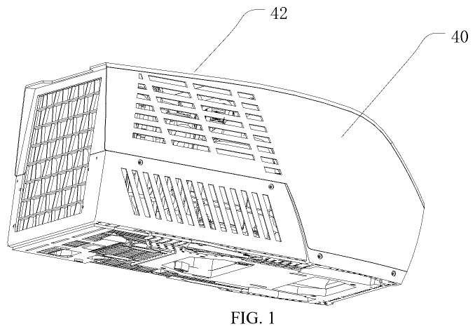

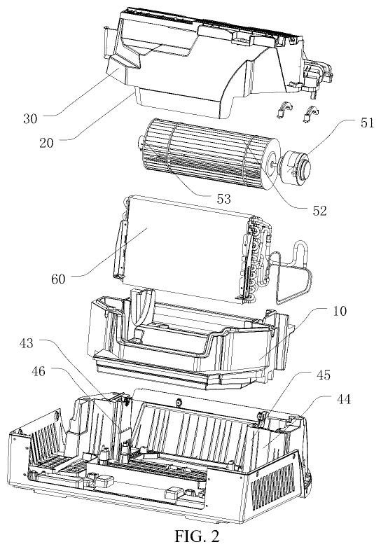

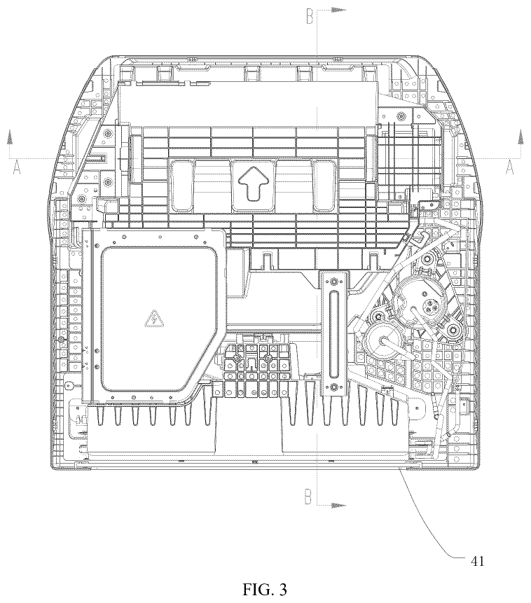

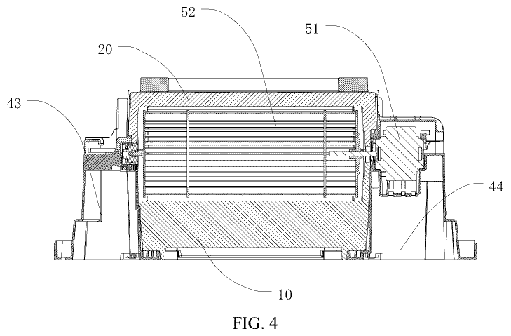

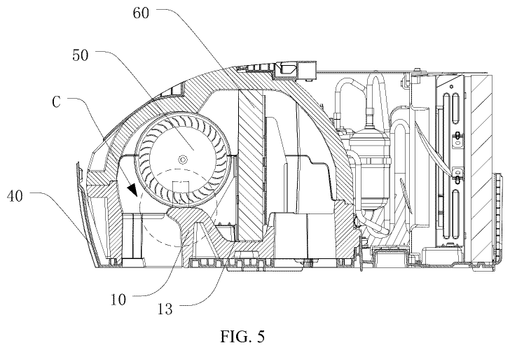

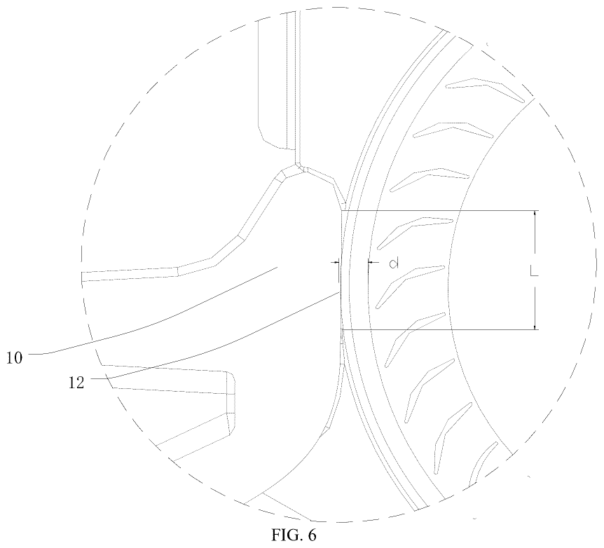

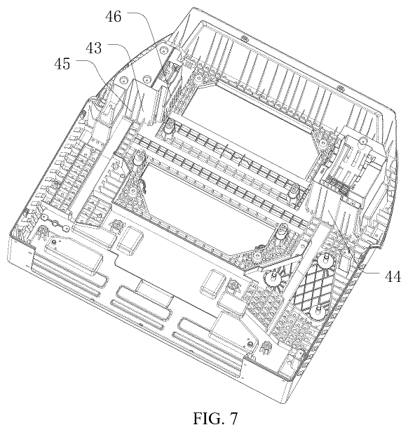

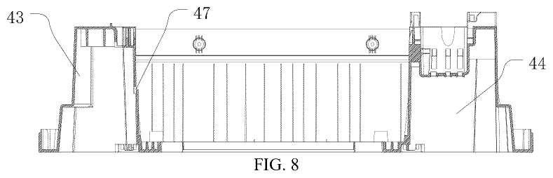

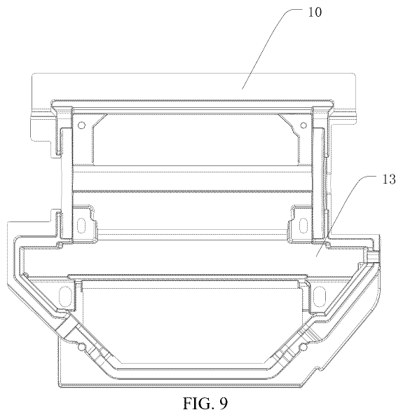

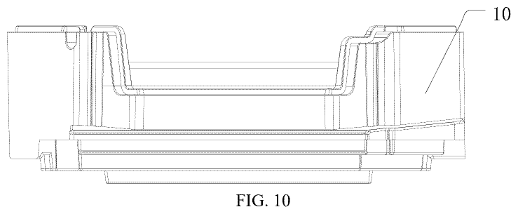

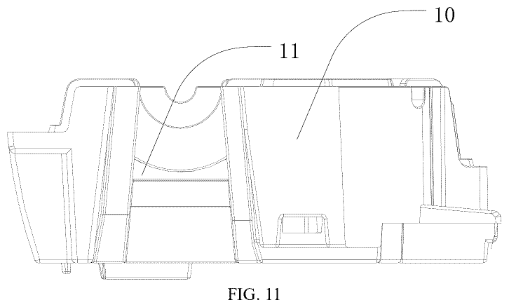

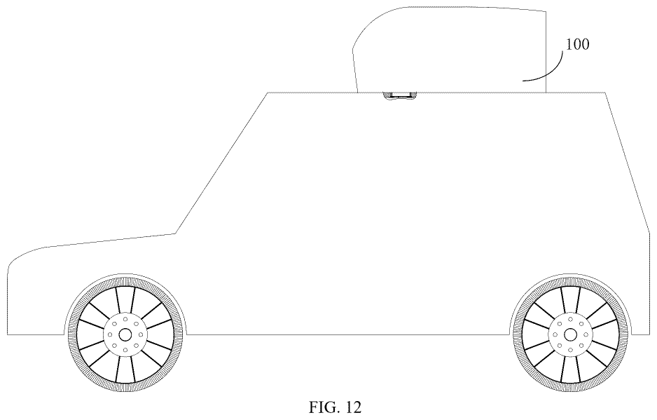

In order to solve the above problem, the present application provides a roof-mounted air conditioner 100 and a vehicle. FIG. 1 is a schematic perspective view of a roof-mounted air conditioner according to an embodiment of the present application. FIG. 2 is an exploded view of the roof-mounted air conditioner in FIG. 1. FIG. 3 is a top view of an internal structure of the roof-mounted air conditioner in FIG. 1. FIG. 4 is a cross-sectional view taken at line A-A in FIG. 3. FIG. 5 is a cross-sectional view taken at line B-B in FIG. 4. FIG. 6 is a partially enlarged view of line C in FIG. 5. FIG. 7 is a schematic perspective view of a chassis in FIG. 1. FIG. 8 is a cross-sectional view of FIG. 7. FIG. 9 is a top view of an air duct support in FIG. 1. FIG. 10 is a front view of the air duct support in FIG. 9. FIG. 11 is a side view of the air duct support in FIG. 9. FIG. 12 is a schematic view of the air conditioner provided by the present application mounted on a vehicle body.

As shown in FIG. 1 to FIG. 12, the roof-mounted air conditioner 100 includes a housing 40, a motor 50 and a mounting structure. The housing is provided with an indoor air duct assembly, the indoor air duct assembly includes an indoor air duct wall structure forming an indoor air duct, and the indoor air duct wall structure is made of a thermal insulation material. The mounting structure includes at least one support platform for mounting a motor 51 of the fan 50 or a bearing base 53, the support platform is mounted at the housing 40 and at least partially located within the indoor air duct. A step is formed at a portion of the support platform located within the indoor air duct, and the step is provided with a water collection groove 46.

In technical solutions of the present application, by setting the indoor air duct wall structure of thermal insulation material, the inner wall of the indoor air duct is made of thermal insulation material, which improves the thermal insulation effect of the indoor air duct, thereby avoiding the formation of condensation water in the indoor air duct and the phenomenon of blowing water on the user. Besides, since the portion of the support platform located in the indoor air duct is not provided with thermal insulation material, condensation water will be formed at it. Accordingly, a water collection groove is provided on the support platform to collect the condensation water generated on the portion of the support platform located in the indoor air duct.

Since the indoor air duct wall structure is made of a thermal insulation material, condensation water will no longer be generated on the indoor air duct wall. When there is water vapor in the air, the water vapor needs to be condensed to form condensation water. Therefore, a step is formed at the portion of the support platform located in the indoor air duct, and a water collection groove 46 is provided on the step, and a drainage hole 47 communicating with the water collection groove 46 is provided on the support platform. In this way, since the portion of the support platform 4 located in the indoor air duct is not provided with thermal insulation material, condensation water will be formed at it. Correspondingly, a water collection groove 46 is provided on the support platform, so that the condensation water generated on the part of the support platform located in the indoor air duct can be collected and discharged to the outside of the indoor air duct through the drainage hole 47, thereby solving the problem of blowing water from the root.

It should be emphasized that the support platform can refer to the bearing support platform 43 or the motor support platform 44, or it can refer to the bearing support platform 43 and the motor support platform 44. The water collection groove 46 and the drainage hole 47 can be set only on the bearing support platform 43, or only on the motor support platform 44. Of course, they can also be set on both the bearing support platform 43 and the motor support platform 44, which is not limited here.

It should be emphasized that the specific implementation of the thermal insulation material is not limited and can be thermal insulation cotton, thermal insulation foam, or the like. In an embodiment, for cost and manufacturing considerations, thermal insulation foam is used.

The indoor air duct wall structure can be integrally formed. This arrangement provides better sealing and higher overall strength, but is more difficult to process, manufacture, and assemble. To facilitate processing, manufacturing, and assembly, the indoor air duct wall structure includes: an air duct support 10 and an air duct cover 20. The air duct cover 20 is disposed above the air duct support 10 and forms the indoor air duct between the air duct support 10 and the air duct cover 20.

The material of the air duct support 10 and the air duct cover 20 is a thermal insulation material. With this arrangement, on the one hand, the air duct support 10 and the air duct cover 20 can be produced separately, and the processing difficulty is relatively low. Moreover, the air duct support 10 and the air duct cover 20 are not difficult to mount.

Meanwhile, since the air duct cover 20 is made of thermal insulation material, common thermal insulation materials, such as thermal insulation cotton or thermal insulation foam, are not strong, and the RV causes usage scenarios, which makes the roof-mounted air conditioner 100 susceptible to hail impact and trampling, stacking pressure damage, etc. Therefore, the indoor air duct assembly also includes an air duct fixation cover 30 provided on the upper side of the air duct cover 20. The air duct fixation cover 30 is made of plastic. With this arrangement, the air duct fixation cover 30 can, on the one hand, press the air duct cover 20 downward, and at the same time, protect the foam air duct, further enhancing the ability of the air duct to resist top impact damage, especially hail impact and trampling, stacking pressure damage, etc.

Further, the mounting structure includes a bearing support platform 43 and a motor support platform 44, at least one of the bearing support platform 43 or the motor support platform 44 forms the support platform, the roof-mounted air conditioner 100 further includes a fan 50, the fan 50 includes a motor 51, an impeller 52 and a bearing base 53, the impeller 52 is provided in the indoor air duct, the motor 51 is mounted at the motor support platform 44, and the bearing base 53 is mounted at the bearing support platform 43. The housing 40 includes a chassis 41 and a top cover 42. The bearing support platform 43 and motor support platform 44 are mounted on the chassis 41, and the top cover 42 covers an upper end of the chassis 41.

Furthermore, the indoor air duct assembly includes an air duct support 10, an air duct cover 20, and an air duct fixation cover 30. The air duct cover 20 is provided above the air duct support 10 to form the indoor air duct therebetween, and the air duct fixation cover 30 is provided above the air duct cover 20. The air duct support 10 is fixed to the chassis 41, and the air duct cover 20 and the air duct fixation cover 30 are fixed to an inner side of the top cover 42.

In an embodiment, when it is necessary to mount the roof-mounted air conditioner 100, directly lower the air duct support 10 from the top of the chassis 41 into the middle of the chassis 41. Due to the limitation of the two support platforms on the front of the chassis 41, the left and right mounting openings of the air duct support 10 can be accurately aligned with the support platforms to assemble the air duct support 10 on the chassis 41, and then mount the indoor heat exchanger 60, fan 50 and other components. Finally, the air duct cover 20 and the air duct fixation cover 30 are mounted first, and then the two assembled parts are pressed down from the top of the air duct support 10, and then screws are used to tighten the screw positions of the air duct fixation cover 30 on the left and right sides of the air duct fixation cover 30 to complete the entire effective compression assembly of the upper and lower foam duct parts. The top duct fixation cover 30 also has certain protection and impact resistance, especially for the pressure impact on the foam duct in high-pressure tests such as stepping tests and stacking tests. Since the air duct is pressed from top to bottom, it can better resist the vibration and shaking impact during the operation of the vehicle.

Since the air duct cover 20 is a foam part, and the left and right ends are partially concave to form the air duct cover bearing top convex edge on the left side and the air duct cover fan shaft top convex edge on the right side, and the left and right side ends of the cavity that accommodates the air duct cover 20 inside the air duct fixation cover 30 are respectively protruded inward to form the fixation cover bearing side step on the left side and the fixation cover fan side step on the right side. The foam convex edge and the step are pressed up and down to form a non-return fit to prevent the foam part of the air duct cover 20 from falling out, forming a stable component pre-tightening assembly. The assembly of the two is achieved by relying on the special combination of the easy-to-deform properties of the foam product of the air duct cover 20 and the extrusion and deformation of the inner cavity of the plastic product of the air duct fixation cover 30. When the foam part of the air duct cover is pressed and assembled into the interior of the plastic air duct fixation cover cavity, the two are deformed at the same time, so that the top convex edge of the air duct cover bearing and the top convex edge of the air duct cover fan shaft pass over the side steps of the fixation cover bearing and the side steps of the fixation cover fan 50, finally forming an anti-slip assembly air duct cover assembly. This assembly process does not require any fixing operations and fasteners, and is extremely efficient.

In an embodiment, the indoor air duct assembly adopts a split form that is split up and down, and is designed with upper and lower air duct main body shells made of insulation material, and an air duct fixation cover 30 of the air duct main body shell is designed on the top. Finally, the air duct form of the lower and upper covers is used to complete the assembly and fixation of the entire fan 50 air duct system; the main structure of the entire core fan 50 air duct has only 3 parts that are snapped together, with high assembly efficiency, good integrity, and high anti-destruction performance.

Furthermore, to ensure effective airflow, the side of the air duct support 10 corresponding to the impeller 52 is recessed inward to form a curved wind surface 12. This arrangement effectively increases the distance between the air duct support 10 and the impeller 52, ensuring balanced airflow and noise levels.

In addition, to ensure consistent distances between each point on the curved wind surface 12 and the outer surface of the impeller 52, a diameter of the curved wind surface 12 is aligned with a diameter of the impeller 52, thereby ensuring balanced airflow and noise levels.

Furthermore, experiments have shown that optimal balanced airflow and noise levels are achieved when the width of the curved wind surface 12 is greater than or equal to 15 mm and the distance between the curved wind surface 12 and the impeller 52 is greater than 4 mm.

Furthermore, the bearing support platform 43 and the motor support platform 44 can be provided separately or integrally with the chassis 41, without limitation.

Taking into account that the RV will be subject to continuous vibration and bumpy vibration caused by uneven roads during use, thereby forming a strong impact, the roof-mounted air conditioner 100 needs to have greater strength, especially the components for mounting the fan 50. If the bearing support platform 43 and the motor support platform 44 are set separately and detachably mounted on the chassis 41, then there are many disassembled parts, the assembly efficiency is extremely low, the structural stability of the whole machine is poor, and it is difficult to withstand the strong impact damage caused by the continuous vibration of the vehicle and the bumpy vibration of the road. Therefore, the product quality is easily affected, and assembly quality problems are very likely to occur, which will lead to major quality accidents with poor quality and many customer complaints.

Therefore, in technical solutions of the present application, the chassis 41, the bearing support platform 43 and the motor support platform 44 are integrally formed. With this arrangement, the chassis 41, the bearing support platform 43 and the motor support platform 44 are integrally formed and non-split, so that the high-speed rotating cross-flow impeller 52, the core of the cross-flow fan air duct, can be directly fixed to the chassis 41 so as to be rotatable around the axis, and the motor 51 is also synchronously fixed to the chassis 41 together with the impeller 52, so that the two have better assembly coaxiality, ensuring that the axis runout during rotation is very small, and thus designing a cross-flow fan air duct system with excellent high-speed rotation stability, and the fan 50 and the impeller fixing structure without an intermediate third support structure, so that it can be directly fixed to the chassis 41 and has better anti-vibration damage characteristics.

Besides, the chassis 41, the bearing support platform 43, and the motor support platform 44 can be integrally injection molded. In this case, there is no assembly relationship, and in actual production, there is no need to assemble these two complete platforms or similar support platform structures, which improves efficiency, improves integrity, and provides high strength and excellent stability. The raised left bearing support platform 43 of the chassis 41 has a larger bottom and smaller top shape, which not only meets the back mold release requirements of industrial manufacturing and has a manufacturable shape, but also greatly improves strength.

Further, a cross-sectional area of the bearing support platform 43 tapers away from the chassis 41, which not only ensures manufacturability in accordance with industrial back-molding requirements, but also significantly enhances strength.

The top of the bearing support platform 43 contains the mounting slot for the bearing base 53 and the screw holes for the air duct cover 30. The top of the fan support platform also contains the fan mounting slot, the screw holes for the air duct cover 30, the screw holes for the fan pressure plate, and the fan pressure plate insertion hole.

A plurality of support platform reinforcement ribs 45 are designed at the base of the peripheral wall of both support platforms, and a plurality of reinforcement ribs 45 connected to the bottom surface of the chassis 41 are also provided at the base of the frontmost wall of the chassis 41. The reinforcement ribs 45 further strengthen the integral strength of the integral injection molding of the support platform and the chassis body, as well as the strength of the front wall of the chassis 41 and the bottom surface of the chassis 41. However, the more important role is that these reinforcement ribs 45 form contact and fit with the air duct support 10 when assembling the cross-flow air duct support 10 foam part. Since the foam air duct support 10 is a foam product, the processing and manufacturing tolerances are very large. The line contact form with ribs can easily accommodate the processing and manufacturing tolerances of the foam. In subsequent production and manufacturing, even if the foam size is too large, it can be strongly compressed and extruded for assembly through contact with the ribs. If there is no reinforcement rib 45, the entire foam surface is in contact with the side wall of the support platform. Once the foam tolerance is too large, the direct surface contact between the foam and the assembly surface is difficult to compress and cannot be assembled with tolerance, resulting in poor product tolerance assembly performance.

A sealing step 11 is formed at the side wall of the bearing support platform 43 mounting opening near the inside of the air duct support 10. This step cooperates with the water collection groove 46 of the middle step position of the bearing support platform 43 on the chassis 41 and/or the motor support platform 44, covers the upper part thereof, and there is a gap between the end face of the sealing step 11 and the side wall of the platform. While achieving the step curve sealing of the upper and lower spaces of step 11 to prevent air leakage, the condensation water on the side wall of the support platform can flow downward along the side wall of the support platform through the gap between the end face of the step and the side wall of the support platform into the condensation receiving groove 46 of the support platform, and finally be discharged to the cross-flow air duct and the outside of the entire machine through the drainage hole 47 of the support platform.

The top surface of the end of the whole wall of the air duct support 10 is a higher lip of the air duct support 10 and a lower outer edge of the air duct support 10. There is a height difference between the two, and the outer high edge and the inner low edge of the air duct cover 20 set at the bottom of the four walls of the cross-flow air duct cover 20 form a staggered stop seal, ensuring the refrigeration gas sealing performance of the entire cross-flow air duct.

Further, in order to collect condensed water generated by the indoor heat exchanger 60, the roof-mounted air conditioner 100 further includes an indoor heat exchanger 60. The air duct support 10 forms a water collection area 13. The indoor heat exchanger 60 is mounted in the water collection area 13 and is located in the indoor air duct.

The air duct support 10 is equipped with indoor air inlets and outlets at the front and rear, respectively, that mate with the chassis 41. Between the inlet and outlet is a water collection area 13, with left and right drain outlets at the left and right ends of the water collection area 13. Two evaporator support platform holes are located near the sides of the air outlet in the water collection area 13, located on the left and right sides of the air inlet. These holes allow the evaporator support platform on the chassis 41 to extend into the interior of the air duct support 10 and rest on a higher support surface, thereby supporting the evaporator component within the cross-flow air duct. There is a pipe outlet groove at the top of the wall of the air duct support 10 above the right drain outlet in the water collection area 13, which is used to connect the pipeline of the evaporator component refrigeration system to the outside of the cross-flow air duct. There is a wire outlet groove at the top of the wall of the air duct support 10 on the left side of the indoor air inlet for the power supply of the whole machine and the passage of communication lines. It should be noted that the air duct support 10 is provided with a bearing support platform 43 mounting opening and a fan 50 support platform mounting opening at the left and right ends of the air outlet, and the two openings are arranged toward the left and right openings of the air duct support 10. However, the two mounting openings are projected on the side surface of the air duct support 10 and are shaped like “\hat{ }” and are opened toward the bottom of the air duct support 10. The advantage is that it meets the requirements of the air duct support 10 foam mold production. Furthermore, the larger opening near the bottom of the air duct support 10 perfectly matches the design of the support platform on the chassis 41, which has a smaller top and a larger bottom. This provides a guide during assembly. After the air duct support 10 is pressed down and assembled on the chassis 41, the smaller upper opening of the mounting opening fits over the smaller top end of the support platform, ensuring a good seal.

It should be noted that in technical solutions of the present application, since the foam air duct cannot have strong support and fix the high-speed rotating cross-flow impeller 52, it cannot support the heavy fan 50. However, it is designed to be flexible in structure and separated from the support and the air duct insulation body on the chassis 41, ultimately combining the advantages of both.

In order to achieve the above purpose, the present application further provides a vehicle, including a vehicle body. A top of the vehicle body is provided with a roof-mounted air conditioner 100 as described above, and the roof-mounted air conditioner 100 includes a housing 40, an indoor air duct assembly is provided in the housing, and the indoor air duct assembly includes an indoor air duct wall structure that forms the indoor air duct, and the indoor air duct wall structure is made of a thermal insulation material.

In technical solutions of the present application, the air conditioner used in the vehicle has an indoor air duct wall structure made of thermal insulation material, so that the inner wall of the indoor air duct is made of thermal insulation material, thereby improving the thermal insulation effect of the indoor air duct, thereby avoiding the formation of condensation water in the indoor air duct and blowing water on the user.

The above description is only some embodiment of the present application and does not limit the scope of the present application. All equivalent structural transformations made by using the contents of the present application description and drawings under the inventive concept of the present application, or direct/indirect application in other related technical fields are included in the scope of the present application.

1.-14. (canceled)

15. A roof-mounted air conditioner comprising:
a housing provided with an indoor air duct assembly, the indoor air duct assembly including an indoor air duct wall structure forming an indoor air duct, and the indoor air duct wall structure being made of a thermal insulation material; and
a mounting structure including a support platform for mounting a fan motor or a bearing base, the support platform being mounted at the housing and at least partially located within the indoor air duct;
wherein a step is formed at a portion of the support platform located within the indoor air duct, and the step is provided with a water collection groove.

16. The roof-mounted air conditioner according to claim 15, wherein the support platform is provided with a drainage hole communicating with the water collection groove.

17. The roof-mounted air conditioner according to claim 15, wherein the indoor air duct wall structure includes:
an air duct support; and
an air duct cover provided above the air duct support and forming the indoor air duct therebetween;
wherein the air duct support and the air duct cover are made of a thermal insulation material.

18. The roof-mounted air conditioner according to claim 17, wherein the indoor air duct assembly further includes an air duct fixation cover provided above the air duct cover, and the air duct fixation cover is made of plastic.

19. The roof-mounted air conditioner according to claim 17, wherein the air duct support is formed with a sealing step above the step.

20. The roof-mounted air conditioner according to claim 17, wherein a side of the air duct support corresponding to the impeller is inwardly recessed to form a curved wind surface.

21. The roof-mounted air conditioner according to claim 20, wherein a width of the curved wind surface is greater than or equal to 15 mm, and a distance between the curved wind surface and the impeller is greater than 4 mm.

22. The roof-mounted air conditioner according to claim 17, further comprising:
an indoor heat exchanger;
wherein the air duct support forms a water collection area, and the indoor heat exchanger is mounted at the water collection area and located within the indoor air duct.

23. The roof-mounted air conditioner according to claim 15, further comprising:
a fan, including a motor, an impeller, and a bearing base;
wherein:
the mounting structure includes a bearing support platform and a motor support platform, and at least one of the bearing support platform or the motor support platform forms the support platform;
the impeller is provided in the indoor air duct, the motor is mounted at the motor support platform, and the bearing base is mounted at the bearing support platform; and
the housing includes:
a chassis on which the bearing support platform and motor support platform are mounted; and
a top cover covering an upper end of the chassis.

24. The roof-mounted air conditioner according to claim 23, wherein the chassis, the bearing support platform, and the motor support platform are integrally formed.

25. The roof-mounted air conditioner according to claim 23, wherein a cross-sectional area of the bearing support platform tapers away from the chassis.

26. The roof-mounted air conditioner according to claim 23, wherein reinforcement ribs are provided between the bearing support platform and the chassis and/or between the motor support platform and the chassis.

27. The roof-mounted air conditioner according to claim 23, wherein:
the indoor air duct assembly includes an air duct support, an air duct cover, and an air duct fixation cover;
the air duct cover is provided above the air duct support to form the indoor air duct between the air duct support and the air duct cover, and the air duct fixation cover is provided above the air duct cover; and
the air duct support is fixed to the chassis, and the air duct cover and the air duct fixation cover are fixed to an inner side of the top cover.

28. A vehicle comprising:
a vehicle body; and
a roof-mounted air conditioner provided at a top of the vehicle body, the roof-mounted air conditioner including:
a housing provided with an indoor air duct assembly, the indoor air duct assembly including an indoor air duct wall structure forming an indoor air duct, and the indoor air duct wall structure being made of a thermal insulation material; and
a mounting structure including at least one support platform for mounting a fan motor or a bearing base, the support platform being mounted at the housing and at least partially located within the indoor air duct;
wherein a step is formed at a portion of the support platform located within the indoor air duct, and the step is provided with a water collection groove.

29. The vehicle according to claim 28, wherein the support platform is provided with a drainage hole communicating with the water collection groove.

30. The vehicle according to claim 28, wherein the indoor air duct wall structure includes:
an air duct support; and
an air duct cover provided above the air duct support and forming the indoor air duct therebetween;
wherein the air duct support and the air duct cover are made of a thermal insulation material.

31. The vehicle according to claim 30, wherein the indoor air duct assembly further includes an air duct fixation cover provided above the air duct cover, and the air duct fixation cover is made of plastic.

32. The vehicle according to claim 30, wherein the air duct support is formed with a sealing step above the step.

33. The vehicle according to claim 30, wherein a side of the air duct support corresponding to the impeller is inwardly recessed to form a curved wind surface.

34. The vehicle according to claim 33, wherein a width of the curved wind surface is greater than or equal to 15 mm, and a distance between the curved wind surface and the impeller is greater than 4 mm.
